(19) United States
(12) Patent Application Publication
(10) Pub. No.: US 2026/0219430 A1
(43) Pub. Date: Jul. 30, 2026

(54) Heads-Up Display Coating

(71) Applicant: Vitro Flat Glass LLC, Cheswick, PA (US)

(72) Inventor: Alexandra Gordienko, Natrona Heights, PA (US)

(21) Appl. No.: 19/039,259

(22) Filed: Jan. 28, 2025

(51) Int. Cl. G02B 5/30; G02B 27/01

(52) U.S. Cl. CPC G02B 5/3083; G02B 5/3066; G02B 27/0101

(57) ABSTRACT

The present invention relates to a laminate having enhanced p-polarized radiation reflecting properties, and, in some embodiments, to a display system for projecting an image and a method of projecting an image onto a heads-up display.

### BACKGROUND OF THE INVENTION

### Field of the Invention

The present invention relates to a laminate having enhanced p-polarized radiation reflecting properties, and, in some embodiments, to a display system for projecting an image and a method of projecting an image onto a heads-up display.

### Description of Related Art

Conventional automotive heads-up displays (HUDs) use an electromagnetic radiation source in the dashboard that projects light up onto the windshield, which is then reflected to the driver's eyes, creating a virtual image of vehicle data so that the driver has access to information about the vehicle's operation without having to look away from the road. For electromagnetic radiation coming from a dashboard and reflecting off of the windshield at angles typically found in a conventional vehicle, the reflected light primarily is s-polarized with a much smaller component of the light being p-polarized. In the extreme case, if the angle of incidence of the electromagnetic radiation to the windshield is the Brewster's angle of an air to glass interface (approximately 57 degrees), the p-polarized reflectance is zero percent.

Light from the radiation source will reflect at least off of both the innermost surface of the windshield and the outermost surface of a plies of glass in a windshield (e.g. the No. 3 and the No. 4 surfaces) due to the index mismatch between air and glass. This leads to at least two reflected images being formed, one from each surface. Multiple images formed in a HUD is a phenomenon referred to as “ghosting.”

For safety purposes, windshields contain an interlayer between the outer and inner plies of glass. This interlayer is another surface where there is an index mismatch that can lead to ghosting. A conventional method of resolving ghosting from this surface is by employing a wedge-shaped vinyl layer between the inner and outer glass plies of the windshield to adjust the geometry of the two glass plies to align the two reflected images.

It is also desirable to apply a coating to at least one of the glass plies to provide solar control, heating, and/or antenna functionality to the windshield. This additional coating leads to another index mismatch within the windshield and another reflected image.

Lastly, there can be reflection at the No. 1 and/or No. 2 surface which creates further ghosting.

Another problem with conventional HUD systems results from the fact that many drivers wear polarized sunglasses to reduce glare from the road and other sources while driving. Typical polarized sunglasses work by filtering the light to allow p-polarized light to pass therethrough. However, in conventional HUD systems, s-polarized radiation is reflected off of the windshield to form the image of the HUD and makes up a significant portion of the light intensity that reaches a driver. This is especially true considering the windshield is typically positioned at an angle near the Brewster's angle for the air to glass interface. Thus, a driver wearing conventional polarized sunglasses may not be able to see the image of the HUD formed by the primarily s-polarized radiation.

Therefore, there is a need in the art for a system and/or components to reduce or eliminate one or more of these problems. For example, it would be desirable to provide a HUD system that projects an image viewable to drivers wearing polarized sunglasses and/or that reduces or eliminates ghosting.

### SUMMARY OF THE INVENTION

The present invention relates to a laminate having enhanced p-polarized radiation reflecting properties, and, in some embodiments, to a system for projecting an image and a method of projecting an image onto a heads-up display.

In one embodiment, the present invention is directed to a laminate, such as a windshield, having enhanced p-polarized radiation reflecting properties. In one embodiment, the laminate includes a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an overcoat positioned over at least a portion of the topcoat layer, wherein the laminate comprises an average p-polarized reflectance of 10-20%, or 13-20%, or even 15-20% across the range of 440 nm to 680 nm at an incidence angle of 60 degrees. In still another embodiment, the enhanced p-polarized reflective coating further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer is positioned over at least a portion of the third metal functional layer.

Further non-limiting embodiments or aspects are set forth and described in the following clauses.

Clause 1: A laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm at an incidence angle of 60 degrees.

Clause 2: The laminate of clause 1, wherein the enhanced p-polarized reflective coating further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

Clause 3: The laminate of clause 2, wherein the first phase adjustment layer and/or the second phase adjustment layer comprises a first film comprising a metal oxide film; a second film positioned over the first film, the second film comprising a metal-alloy oxide film; and a third film positioned over the second film, the third film comprising a metal oxide film.

Clause 4: The laminate of clause 3, wherein any of the metal oxide films of the first film and/or third film are formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 5: The laminate of clause 3, wherein the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 6: The laminate of any of clauses 1-5, wherein the laminate comprises an average p-polarized reflectance of 10-20% across the range of 470 nm to 620 nm at an incidence angle of 60 degrees.

Clause 7: The laminate of any of clauses 1-6, wherein the laminate comprises a p-polarized reflectance of 15-20% at 530 nm at an incidence angle of 60 degrees.

Clause 8: The laminate of any of clauses 1-7, wherein the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

Clause 9: The laminate of any of clauses 1-8, wherein the topcoat layer comprises first film comprising a metal oxide, a metal-alloy oxide, a metal nitride, or a metal alloy-nitride, and a second film over the first film of the topcoat layer comprising a metal oxide, a metal-alloy oxide, a metal nitride, a metal alloy-nitride, a metal oxynitride, or a metal alloy oxynitride that is different than the material used to form the first film of the topcoat layer.

Clause 10: The laminate of any of clauses 2-9, further comprising one or more of a first primer over the first metal functional layer, a second primer over the second metal functional layer, and/or a third primer over the third metal functional layer.

Clause 11: A system for projecting an image comprising a projector configured to project a p-polarized image towards a laminate having enhanced p-polarized radiation reflecting properties, the laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm.

Clause 12: The system of clause 11, wherein the enhanced p-polarized reflective coating further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

Clause 13: The system of clause 12, wherein the first phase adjustment layer and/or the second phase adjustment layer comprises a first film comprising a metal oxide film; a second film positioned over the first film, the second film comprising a metal-alloy oxide film; and a third film positioned over the second film, the third film comprising a metal oxide film.

Clause 14: The system of clause 13, wherein any of the metal oxide films of the first film and/or third film are formed from either (i) a first layer of zinc oxide, a layer of zinc stannate formed over the first layer of zinc oxide, and a second zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 15: The system of clause 13, wherein the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 16: The system of any of clauses 11-15, wherein the laminate comprises an average p-polarized reflectance of 10-20% across the range of 470 nm to 620 nm at an incidence angle of 60 degrees.

Clause 17: The system of any of clauses 11-16, wherein the laminate comprises a p-polarized reflectance of 15-20% at 530 nm at an incidence angle of 60 degrees.

Clause 18: The system of any of clauses 11-17, wherein the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

Clause 19: The system of any of clauses 11-18, wherein the topcoat layer comprises first film comprising a metal oxide, a metal-alloy oxide, a metal nitride, or a metal alloy-nitride, and a second film over the first film of the topcoat layer comprising a metal oxide, a metal-alloy oxide, a metal nitride, a metal alloy-nitride, a metal oxynitride, or a metal alloy oxynitride that is different than the material used to form the first film of the topcoat layer.

Clause 20: The system of any of clauses 12-19, further comprising one or more of a first primer over the first metal functional layer, a second primer over the second metal functional layer, and/or a third primer over the third metal functional layer.

Clause 21: A method for reflecting p-polarized light, the method comprising the steps of providing at least one projector configured to project a p-polarized image towards a laminate having enhanced p-polarized radiation reflecting properties; and projecting at least one p-polarized light image towards the laminate, wherein the laminate comprises a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm.

Clause 22 The method of clause 21, wherein the enhanced p-polarized reflective coating further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

Clause 23: The method of clause 22, wherein the first phase adjustment layer and/or the second phase adjustment layer comprises a first film comprising a metal oxide film; a second film positioned over the first film, the second film comprising a metal-alloy oxide film; and a third film positioned over the second film, the third film comprising a metal oxide film.

Clause 24: The method of clause 23, wherein any of the metal oxide films of the first film and/or third film are formed from either (i) a first layer of zinc oxide, a layer of zinc stannate formed over the first layer of zinc oxide, and a second zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 25: The method of clause 23, wherein the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 26: The method of any of clauses 21-25, wherein the laminate comprises an average p-polarized reflectance of 10-20% across the range of 470 nm to 620 nm at an incidence angle of 60 degrees.

Clause 27: The method of any of clauses 21-26, wherein the laminate comprises a p-polarized reflectance of 15-20% at 530 nm at an incidence angle of 60 degrees.

Clause 28: The method of any of clauses 21-27, wherein the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

Clause 29: The method of any of clauses 21-28, wherein the topcoat layer comprises first film comprising a metal oxide, a metal-alloy oxide, a metal nitride or a metal alloy-nitride, and a second film over the first film of the topcoat layer comprising a metal oxide, a metal-alloy oxide, a metal nitride, a metal alloy-nitride, a metal oxynitride or a metal alloy oxynitride that is different than the material used to form the first film of the topcoat layer.

Clause 30: The method of any of clauses 22-29, further comprising one or more of a first primer over the first metal functional layer, a second primer over the second metal functional layer, and/or a third primer over the third metal functional layer.

Clause 31: A vehicle having at least one display system designed to reflect p-polarized light, the display system comprising a projector configured to project a p-polarized image towards a laminate having enhanced p-polarized radiation reflecting properties; and at least one laminate designed to reflect p-polarized light, the laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm.

Clause 32: The vehicle of clause 31, wherein the enhanced p-polarized reflective coating further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

Clause 33: The vehicle of clause 32, wherein the first phase adjustment layer and/or the second phase adjustment layer comprises a first film comprising a metal oxide film; a second film positioned over the first film, the second film comprising a metal-alloy oxide film; and a third film positioned over the second film, the third film comprising a metal oxide film.

Clause 34: The vehicle of clause 33, wherein any of the metal oxide films of the first film and/or third film are formed from either (i) a first layer of zinc oxide, a layer of zinc stannate formed over the first layer of zinc oxide, and a second zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 35: The vehicle of clause 33, wherein the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

Clause 36: The vehicle of any of clauses 31-35, wherein the laminate comprises an average p-polarized reflectance of 10-20% across the range of 470 nm to 620 nm at an incidence angle of 60 degrees.

Clause 37: The vehicle of any of clauses 31-36, wherein the laminate comprises a p-polarized reflectance of 15-20% at 530 nm at an incidence angle of 60 degrees.

Clause 38: The vehicle of any of clauses 31-37, wherein the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

Clause 39: The vehicle of any of clauses 31-38, wherein the topcoat layer comprises first film comprising a metal oxide, a metal-alloy oxide, a metal nitride or a metal alloy-nitride, and a second film over the first film of the topcoat layer comprising a metal oxide, a metal-alloy oxide, a metal nitride, a metal alloy-nitride, a metal oxynitride or a metal alloy oxynitride that is different than the material used to form the first film of the topcoat layer.

Clause 40: The vehicle of any of clauses 32-39, further comprising one or more of a first primer over the first metal functional layer, a second primer over the second metal functional layer, and/or a third primer over the third metal functional layer.

### BRIEF DESCRIPTION OF THE DRAWINGS

FIG. 1 is a perspective view (not to scale) of a display system including a laminate and a radiation source;

FIGS. 2A-2F are side views (not to scale) of various examples of a laminate having an enhanced p-polarized reflective coating;

FIGS. 3A and 3B are side views (not to scale) of enhanced p-polarized reflective coatings located over a substrate;

FIGS. 4A and 4B are side views (not to scale) of enhanced p-polarized reflective coatings located over a substrate;

FIG. 5A is a side view (not to scale) of a laminate including two plies and having a wedge-shaped interlayer;

FIG. 5B is a side view (not to scale) of a laminate including two plies having an interlayer of continuous thickness;

FIG. 6 is a perspective view (not to scale) of a laminate having an enhanced p-polarized reflective coating on a fourth surface and a radiation source positioned such that radiation from the radiation source contacts a first surface of the laminate at a Brewster's angle of a first surface to air interface; and

FIG. 7 is a perspective view (not to scale) of a test apparatus for which radiation from a radiation source contacts a laminate at an angle of 60 degrees relative to normal of the laminate.

### DETAILED DESCRIPTION OF THE INVENTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

Moreover, other than in any operating examples, or where otherwise indicated, all numbers used in the specification and claims are to be understood as being modified in all instances by the term “about”. Accordingly, unless indicated to the contrary, the numerical parameters set forth in the following specification and attached claims are approximations that can vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

With respect to coating layers described herein, the term “over” means farther from the substrate on which the coating layer is positioned. For example, a second layer positioned “over” a first layer means that the second layer is positioned farther from the substrate than is the first layer. The second layer can be in direct contact with the first layer. Alternatively, one or more other layers can be positioned between the first layer and the second layer.

The term “film” means a region having a distinct composition. A “layer” can include one or more “films”. A “coating” can include one or more “layers”.

The terms “polymer” or “polymeric” include oligomers, homopolymers, copolymers, and terpolymers, e.g., polymers formed from two or more types of monomers or polymers.

The term “ultraviolet radiation” means electromagnetic radiation having a wavelength in the range of 100 nm to less than 300 nm. The term “visible radiation” means electromagnetic radiation having a wavelength in the range of 380 nm to 780 nm. The term “infrared radiation” means electromagnetic radiation having a wavelength in the range of greater than 780 nm to 100,000 nm. The term “solar infrared radiation” means electromagnetic radiation having a wavelength in the range of 1,000 nm to 3,000 nm. The term “thermal infrared radiation” means electromagnetic radiation having a wavelength in the range of greater than 3,000 nm to 20,000 nm.

The terms “metal” and “metal oxide” include silicon and silica, respectively, as well as traditionally recognized metals and metal oxides, even though silicon conventionally may not be considered a metal. By “at least” is meant “greater than or equal to”. By “not greater than” is meant “less than or equal to”. The term “includes” is synonymous with “comprises”.

The discussion of the invention may describe certain features as being “particularly” or “preferably” within certain limitations (e.g., “preferably”, “more preferably”, or “even more preferably”, within certain limitations). It is to be understood that the invention is not limited to these particular or preferred limitations but encompasses the entire scope of the disclosure.

In one embodiment, the present invention relates to a laminate having enhanced p-polarized radiation reflecting properties comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm at an incidence angle of 60 degrees.

In another embodiment, the laminate of the present invention has an enhanced p-polarized reflective coating that further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

In another embodiment, the laminate of the present invention has an enhanced p-polarized reflective coating that comprises a first phase adjustment layer and/or a second phase adjustment layer that comprise a first film comprising a metal oxide film; a second film positioned over the first film, the second film comprising a metal-alloy oxide film; and a third film positioned over the second film, the third film comprising a metal oxide film.

In another embodiment, the laminate of the present invention has an enhanced p-polarized reflective coating where any of the metal oxide films of the first film and/or third film are formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

In another embodiment, the laminate of the present invention has an enhanced p-polarized reflective coating where the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

In another embodiment, the laminate of the present invention has an enhanced p-polarized reflective coating where the laminate comprises an average p-polarized reflectance of 10-20% across the range of 470 nm to 620 nm at an incidence angle of 60 degrees. In another embodiment, the laminate of the present invention has an enhanced p-polarized reflective coating that comprises wherein the laminate comprises a p-polarized reflectance of 15-20% at 530 nm at an incidence angle of 60 degrees.

In another embodiment, the laminate of the present invention has an enhanced p-polarized reflective coating where the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

In another embodiment, the laminate of the present invention has an enhanced p-polarized reflective coating where the topcoat layer comprises first film comprising a metal oxide, a metal-alloy oxide, a metal nitride, or a metal alloy-nitride, and a second film over the first film of the topcoat layer comprising a metal oxide, a metal-alloy oxide, a metal nitride, a metal alloy-nitride, a metal oxynitride, or a metal alloy oxynitride that is different than the material used to form the first film of the topcoat layer.

In another embodiment, the laminate of the present invention has an enhanced p-polarized reflective coating that further comprises a first primer over the first metal functional layer. In another embodiment, the laminate of the present invention has an enhanced p-polarized reflective coating that further comprises a second primer over the second metal functional layer. In another embodiment, the laminate of the present invention has an enhanced p-polarized reflective coating that further comprises a third primer over the third metal functional layer.

In still another embodiment, the present invention relates to a system for projecting an image comprising a projector configured to project a p-polarized image towards a laminate having enhanced p-polarized radiation reflecting properties, the laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm.

In still another embodiment, the system of the present invention has an enhanced p-polarized reflective coating that further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

In still another embodiment, the system of the present invention has an enhanced p-polarized reflective coating that comprises a first phase adjustment layer and/or a second phase adjustment layer that comprise a first film comprising a metal oxide film; a second film positioned over the first film, the second film comprising a metal-alloy oxide film; and a third film positioned over the second film, the third film comprising a metal oxide film.

In still another embodiment, the system of the present invention has an enhanced p-polarized reflective coating where any of the metal oxide films of the first film and/or third film are formed from either (i) a first layer of zinc oxide, a layer of zinc stannate formed over the first layer of zinc oxide, and a second zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

In still another embodiment, the system of the present invention has an enhanced p-polarized reflective coating where the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

In still another embodiment, the system of the present invention has an enhanced p-polarized reflective coating where the laminate comprises an average p-polarized reflectance of 10-20% across the range of 470 nm to 620 nm at an incidence angle of 60 degrees. In still another embodiment, the system of the present invention has an enhanced p-polarized reflective coating where the laminate comprises a p-polarized reflectance of 15-20% at 530 nm at an incidence angle of 60 degrees.

In still another embodiment, the system of the present invention has an enhanced p-polarized reflective coating where the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

In still another embodiment, the system of the present invention has an enhanced p-polarized reflective coating where the topcoat layer comprises first film comprising a metal oxide, a metal-alloy oxide, a metal nitride, or a metal alloy-nitride, and a second film over the first film of the topcoat layer comprising a metal oxide, a metal-alloy oxide, a metal nitride, a metal alloy-nitride, a metal oxynitride, or a metal alloy oxynitride that is different than the material used to form the first film of the topcoat layer.

In still another embodiment, the system of the present invention has an enhanced p-polarized reflective coating that further comprises a first primer over the first metal functional layer. In still another embodiment, the system of the present invention has an enhanced p-polarized reflective coating that further comprises a second primer over the second metal functional layer. In still another embodiment, the system of the present invention has an enhanced p-polarized reflective coating that further comprises a third primer over the third metal functional layer.

In still another embodiment, the system of the present invention has an enhanced p-polarized reflective coating where the projector is configured to project the p-polarized image towards the laminate.

In still another embodiment, the present invention relates to a method for reflecting p-polarized light, the method comprising the steps of providing at least one projector configured to project a p-polarized image towards a laminate having enhanced p-polarized radiation reflecting properties; and projecting at least one p-polarized light image towards the laminate, wherein the laminate comprises a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm.

In still another embodiment, the method of the present invention utilizes any of the enhanced p-polarized reflective coatings disclosed herein.

In still another embodiment, the present invention relates to a vehicle having at least one display system designed to reflect p-polarized light, the display system comprising a projector configured to project a p-polarized image towards a laminate having enhanced p-polarized radiation reflecting properties; and at least one laminate designed to reflect p-polarized light, the laminate comprising a first ply comprising a first surface and a second surface opposite the first surface, wherein the first surface comprises an outer surface of the laminate; a second ply comprising a third surface adjacent the second surface and a fourth surface opposite the third surface, wherein the fourth surface comprises an inner surface of the laminate; an interlayer positioned between the first ply and the second ply; and an enhanced p-polarized reflective coating positioned over at least a portion of at least one of the second surface and/or third surface, wherein the enhanced p-polarized reflective coating comprises a base layer positioned over the portion of the at least one of the surfaces; a first metal functional layer positioned over at least a portion of the base layer; a first phase adjustment layer positioned over at least a portion of the first metal functional layer; a second metal functional layer positioned over at least a portion of the first phase adjustment layer; a topcoat layer positioned over at least a portion of the second metal functional layer; and an optional overcoat positioned over at least a portion of the topcoat layer, wherein the laminate comprises an average p-polarized reflectance of 10-20%, or 13-20%, or even 15-20% across the range of 440 nm to 680 nm.

In still another embodiment, a vehicle according to the present invention utilizes any of the enhanced p-polarized reflective coatings disclosed herein.

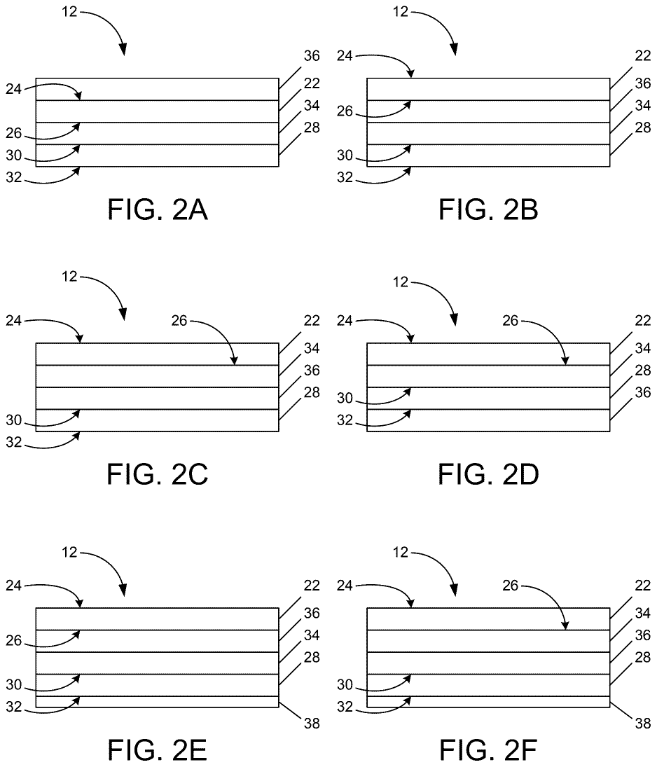

Given the above, it should be noted that any of the above laminates can be used in place of any of the laminates described below with regard to FIGS. 2A-2F, 3A, 3B, 4A, 4B, 5A, 5B, and/or 6 to achieve an enhanced p-polarized reflective coating described below.

### Display System

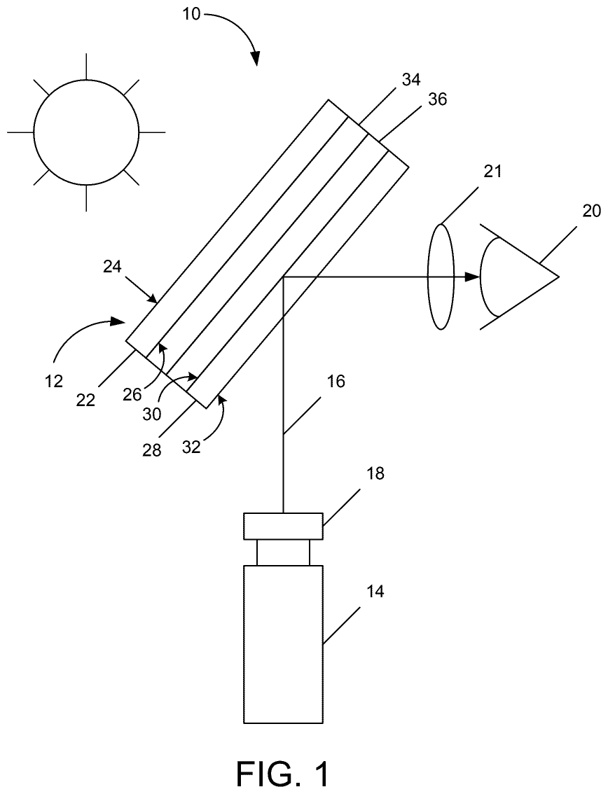

Referring to FIG. 1, a display system 10 according to the present invention is shown. Display system 10 can be a heads-up display (HUD) in a vehicle, such as a heads-up display in an automobile or aircraft. However, display system 10 is not limited to heads-up displays in vehicles and can be any type of display projecting an image. Non-limiting examples of displays that can be considered the “display system” include advertising, promotional, or informational displays, and the like. Display system 10 may project an image visible to humans (e.g., within the visible spectrum). Alternatively, display system 10 may project an image in a non-visible region of the electromagnetic spectrum.

With continued reference to FIG. 1, display system 10 includes a laminate 12 and a radiation source 14. Radiation source 14 can emit electromagnetic radiation 16 or any other desired form of radiation. Radiation source 14 can emit radiation 16 across the entire radiation spectrum, or across only a portion thereof (e.g., across the visible spectrum, ultraviolet radiation, infrared radiation, and the like, as well as combinations thereof). Radiation source 14 can emit white light as radiation 16. Radiation 16 can include s-polarized radiation and/or p-polarized radiation. By “s-polarized radiation” it is meant that radiation 16 has an electric field normal to the plane of incidence. By “p-polarized radiation” it is meant that radiation 16 has an electric field along the plane of incidence. “Angle of incidence” is defined as the angle between a ray of radiation incident on a surface to a line normal to the surface at the point of incidence. Radiation source 14 can emit radiation 16 directed at laminate 12 such that radiation 16 contacts laminate 12 at at least one point.

With continued reference to FIG. 1, display system 10 can further include a polarized filter 18. Polarized filter 18 can be positioned between radiation source 14 and laminate 12. Polarized filter 18 can be designed to permit at least a portion of the p-polarized and/or the s-polarized radiation to pass therethrough. Polarized filter 18 can alternatively be designed to permit only p-polarized radiation to pass therethrough. Polarized filter 18 can be designed to filter at least a portion of the s-polarized radiation, such that the filtered portion cannot pass therethrough. Polarized filter 18 can further, or alternatively, be designed to filter substantially all of the s-polarized radiation, such that substantially all of the s-polarized radiation cannot pass therethrough. Substantially all, in this context, means that polarized filter 18 filters at least 95 percent of the s-polarized radiation, such as at least 97 percent, at least 99 percent, or 100 percent of the s-polarized radiation.

With continued reference to FIG. 1, radiation source 14 can emit radiation 16 that is directed off of laminate 12, such that at least a portion of radiation 16 is reflected off of laminate 12 and is directed to an eye 20 of a user. The portion of the radiation not reflected off of laminate 12, can be refracted, absorbed, or otherwise transmitted through laminate 12. The user may be wearing polarized sunglasses 21, and radiation 16 that is directed to the eye 20 of the user may be directed toward polarized sunglasses 21. In one non-limiting embodiment, polarized sunglasses 21 can filter s-polarized radiation such that at least a portion of the s-polarized radiation cannot pass therethrough.

With continued reference to FIG. 1, when radiation source 14 emits radiation 16 directed at laminate 12, an image can be projected to an area on an inner side of laminate 12, and the image can be viewable to eye 20 of a user. The image of display system 10 can be static or dynamic. The image can include colors and can be a monochromatic image or a polychromatic image. The image can be an image in a HUD. The HUD can be a HUD in an automobile or other vehicle. In this example, laminate 12 can be a windshield, or other laminate 12 in a vehicle, and radiation source 14 can be directed at laminate 12 to display an image so that the driver (or other user) may see the image while operating the vehicle.

### Laminate

Referring to FIG. 1 and FIGS. 2A-2F, various examples of laminate 12 of the present invention are shown. Laminate 12 can include a first ply 22 having a first surface 24 (No. 1 surface) and an opposite second surface 26 (No. 2 surface). Laminate 12 includes a second ply 28 having a third surface 30 (No. 3 surface) and an opposite fourth surface 32 (No. 4 surface). An interlayer 34 can be positioned between second surface 26 and third surface 30. Referring to FIG. 1, first surface 24 can be an outer surface of laminate 12, and fourth surface 32 can be an inner surface of laminate 12. In the case of laminate 12 being a windshield of a vehicle, first surface 24 can be the surface closest to the sun, while fourth surface 32 can be the surface closest to an interior of the vehicle. In this way, fourth surface 32 can be the surface of laminate 12 closest to radiation source 14 positioned inside the vehicle and directed at laminate 12.

First ply 22 and/or second ply 28 can be transparent or translucent to visible radiation. By “transparent” is meant having visible radiation transmittance of greater than 0 percent up to 100 percent. Alternatively, the ply can be translucent. By “translucent” is meant diffusing visible radiation such that objects on the side opposite a viewer are not clearly visible. Examples of suitable materials include, but are not limited to, plastic substrates (such as acrylic polymers, such as polyacrylates; polyalkylmethacrylates, such as polymethylmethacrylates, polyethylmethacrylates, polypropylmethacrylates, and the like; polyurethanes; polycarbonates; polyalkylterephthalates, such as polyethyleneterephthalate (PET), polypropyleneterephthalates, polybutyleneterephthalates, and the like; polysiloxane-containing polymers; or copolymers of any monomers for preparing these, or any mixtures thereof); ceramic substrates; glass substrates; or mixtures or combinations of any of the above. For example, plies 22 and/or 28 can include conventional soda-lime-silicate glass, borosilicate glass, or leaded glass. The glass can be clear glass. By “clear glass” is meant non-tinted or non-colored glass. Alternatively, the glass can be tinted or otherwise colored glass. The glass can be annealed or heat-treated glass. As used herein, the term “heat treated” means tempered or at least partially tempered. The glass can be of any type, such as conventional float glass, and can be of any composition having any optical properties, e.g., any value of visible radiation transmittance, ultraviolet radiation transmittance, infrared radiation transmittance, and/or total solar energy transmittance. By “float glass” is meant glass formed by a conventional float process in which molten glass is deposited onto a molten metal bath and controllably cooled to form a float glass ribbon.

First ply and/or second ply 22 and/or 28 can be, for example, clear float glass or can be tinted or colored glass. Plies 22 and/or 28 can be of any desired dimensions, e.g., length, width, shape, or thickness. Non-limiting examples of glass that can be used for the practice of the invention include clear glass, Starphire®, Solargreen®, Solextra®, GL-20®, GL-35™, Solarbronze®, Solargray® glass, Pacifica® glass, SolarBlue® glass, and Optiblue® glass, all commercially available from Vitro Architectural Glass of Pittsburgh, Pennsylvania.

The other of first ply 22 and second ply 28 can be of any of the materials described above for first ply 22 and/or second ply 28. First ply 22 and second ply 28 can be the same or different from one another. First and second plies 22 and/or 28 can each be, for example, clear float glass or can be tinted or colored glass or one ply 22 and/or 28 can be clear glass and the other ply 22 and/or 28 colored glass.

With continued reference to FIGS. 2A-2F, laminate 12 can also include an enhanced p-polarized reflective coating 36 positioned over at least a portion of one of surfaces 24, 26, 30, and/or 32 of plies 22 and/or 28. In FIG. 2A, enhanced p-polarized reflective coating 36 is positioned over first surface 24. In FIG. 2B, enhanced p-polarized reflective coating 36 is positioned over second surface 26. In FIG. 2C, enhanced p-polarized reflective coating 36 is positioned over third surface 30. In FIG. 2D, enhanced p-polarized reflective coating 36 is positioned over fourth surface 32.

With continued reference to FIGS. 2E-2F, laminate 12 can include further coating layers beyond enhanced p-polarized reflective coating 36. Laminate 12 can include an anti-reflective coating 38 positioned over one of surfaces 24, 26, 30, and/or 32 of plies 22 and/or 28. As shown in FIGS. 2E and 2F, anti-reflective coating 38 can be positioned over fourth surface 32 when enhanced p-polarized reflective coating 36 is positioned over second surface 26 (FIG. 2E) or third surface 30 (FIG. 2F).

### Enhanced P-Polarized Reflective Coating

As noted above, any of the above laminates disclosed herein can be used in place of any of the laminates described below to achieve an enhanced p-polarized reflective coating described below.

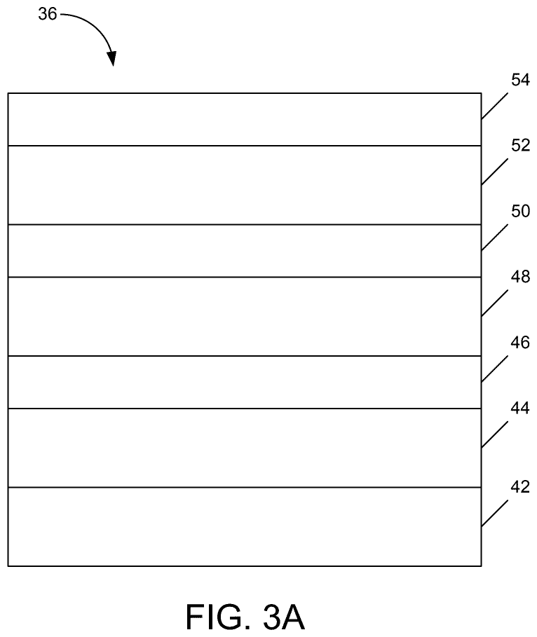

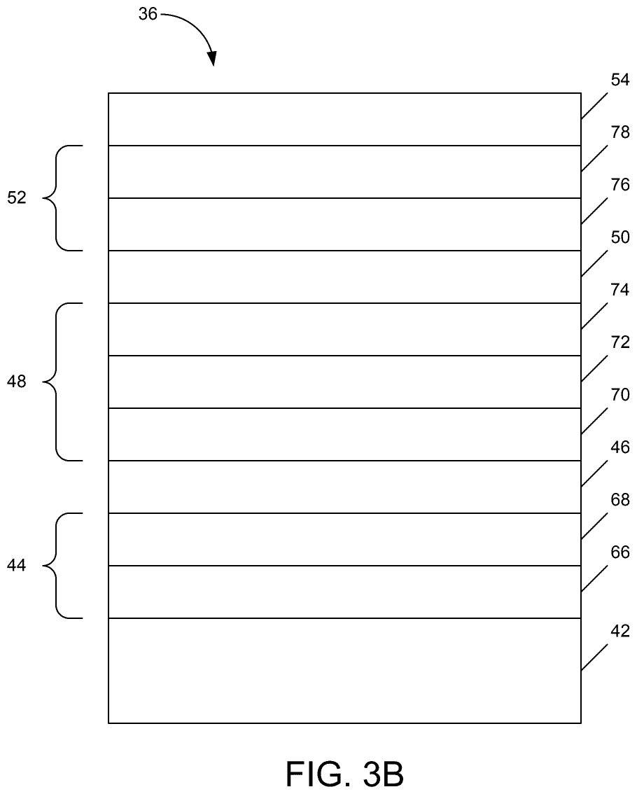

Referring to FIGS. 3A and 3B, enhanced p-polarized reflective coating 36 can be a double metal functional layer enhanced p-polarized reflective coating 36. In the double metal functional layer enhanced p-polarized reflective coating 36, a base layer 44 can be positioned over a substrate 42 (substrate 42 being one of previously described surfaces 24, 26, 30, and/or 32). A first metal functional layer 46 can be positioned over base layer 44. A first phase adjustment layer 48 can be positioned over first metal functional layer 46. A second metal functional layer 50 can be positioned over first phase adjustment layer 48. A topcoat layer 52 can be positioned over second metal functional layer 50. In some embodiments, an overcoat 54 can be positioned over topcoat layer 52.

Referring to FIG. 3B, at least one of the layers in enhanced p-polarized reflective coating 36 of the double metal functional layer enhanced p-polarized reflective coating 36 can include multiple layers. Base layer 44 can include a first film 66 and a second film 68. First film 66 can be positioned over substrate 42 and second film 68 can be positioned over first film 66. First phase adjustment layer 48 can include a first film 70, a second film 72, and a third film 74. First film 70 can be positioned over first metal functional layer 46. Second film 72 can be positioned over first film 70 and third film 74 can be positioned over second film 72. Topcoat layer 52 can include a first film 76 and a second film 78. First film 76 can be positioned over second metal functional layer 50, and second film 78 can be positioned over first film 76.

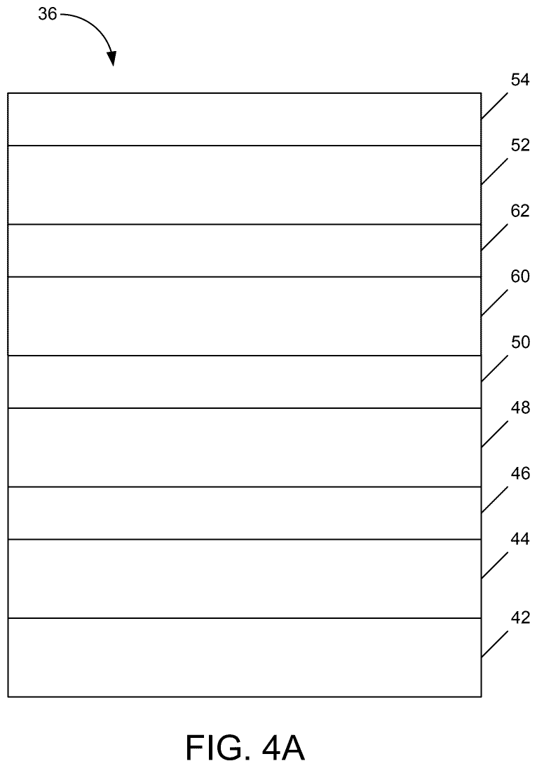

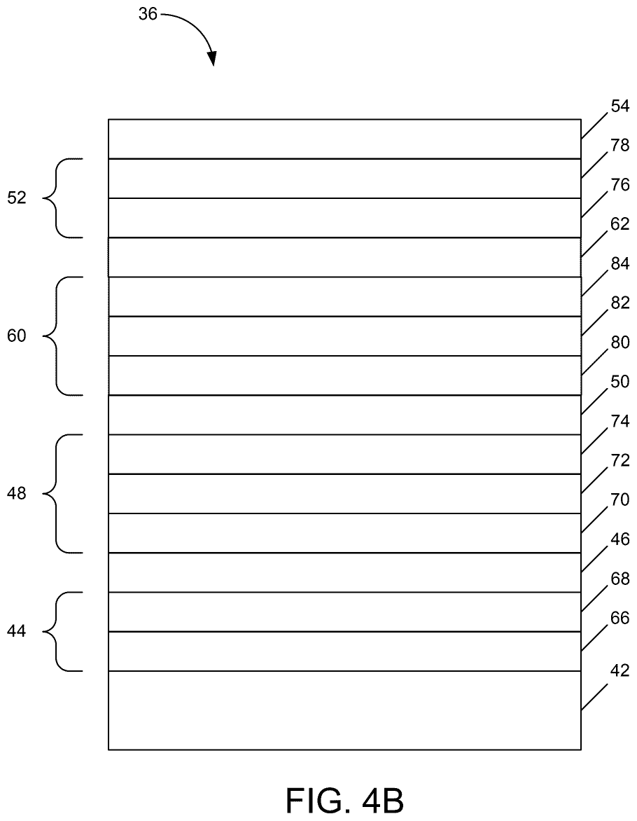

Referring to FIGS. 4A and 4B, enhanced p-polarized reflective coating 36 can be a triple metal functional enhanced reflective coating 36, which includes several additional layers compared to the double metal functional layer enhanced p-polarized reflective coating 36 of FIGS. 3A and 3B. The triple metal functional enhanced p-polarized reflective coating 36 can further include (compared to the double metal functional layer enhanced p-polarized reflective coating 36) a second phase adjustment layer 60 positioned over second metal functional layer 50. A third metal functional layer 62 can be positioned over second phase adjustment layer 60. Topcoat layer 52 and overcoat layer 54 (previously described) can be positioned over third metal functional layer 62.

Referring to FIG. 4B, at least one of the layers in enhanced p-polarized reflective coating 36 of the triple metal functional layer enhanced p-polarized reflective coating 36 can include multiple layers. In addition to those described in the double metal functional layer enhanced p-polarized reflective coating 36 (see FIG. 3B), second phase adjustment layer 60 of the triple metal functional layer enhanced p-polarized reflective coating 36 can have multiple layers. Second phase adjustment layer 60 can include a first film 80, a second film 82, and a third film 84. First film 80 can be positioned over second metal functional layer 50. Second film 82 can be positioned over first film 80, and third film 84 can be positioned over second film 82. In multi-layer topcoat layer 52 previously described, first film 76 can be positioned over third metal functional layer 62.

Based on this disclosure, it will be appreciated that further repeating coating units are within the scope of the invention. For example, adding additional phase adjustment layers, metal functional layers, and/or primer layers (e.g., to form quadruple, quintuple, and the like, metal functional layer enhanced p-polarized reflective coatings 36) is also contemplated by this disclosure.

Enhanced p-polarized reflective coating 36 can be an electro-conductive low emissivity coating that allows visible wavelength energy to be transmitted through the coating but reflects longer wavelength solar infrared energy. By “low emissivity” is meant emissivity less than 0.4, such as less than 0.3, such as less than 0.2, such as less than 0.1, e.g., less than or equal to 0.05.

In one embodiment, enhanced p-polarized reflective coating 36, when applied to substrate 42, can make substrate 42 neutral in color such that the reflectivity for color value a* and/or b* is between −2 and 2, in accordance with 1976 CIELAB color system specified by the International Commission on Illumination. In another embodiment, the laminates of the present invention can have various other optical, color, and/or light reflecting properties as described herein. Substrate 42 can have a low exterior reflectance, such that the reflectance is less than or equal to 30 percent, such as less than or equal to 15 percent, when observing substrate 42 from an angle normal to substrate 42.

Enhanced p-polarized reflective coating 36 can be deposited on substrate 42 by any conventional method. Examples of such methods include conventional chemical vapor deposition (CVD) and/or physical vapor deposition (PVD) methods. Examples of CVD processes include spray pyrolysis. Examples of PVD processes include electron beam evaporation and vacuum sputtering (such as magnetron sputter vapor deposition (MSVD)). Other coating methods could also be used, such as, but not limited to, sol-gel deposition. In one non-limiting embodiment, enhanced p-polarized reflective coating 36 can be deposited by MSVD.

Enhanced p-polarized reflective coating 36 can be deposited over a portion of or the entire surface of substrate 42. In some examples, enhanced p-polarized reflective coating 36 can be deposited over a first larger region of substrate 42 and then a portion of the first larger region can be “deleted” so that enhanced p-polarized reflective coating 36 is positioned over a second smaller region, which is a sub-region of the first larger region.

### Base Layer

Base layer 44 can include a nonmetallic layer(s). For example, base 44 layer can include dielectric or semiconductor materials. For example, base layer 44 can include oxides, nitrides, oxynitrides, and/or mixtures thereof. Examples of suitable materials for base layer 44 can include oxides, nitrides, or oxynitrides of titanium, hafnium, zirconium, niobium, zinc, bismuth, lead, indium, tin, and mixtures thereof. These may have small amounts of other materials, such as manganese in bismuth oxide, tin in indium oxide, etc. Additionally, oxides of metal alloys or metal mixtures can be used, such as oxides containing zinc and tin (e.g., zinc stannate), oxides of indium-tin alloys, silicon nitrides, silicon aluminum nitrides, or aluminum nitrides. Further, doped metal oxides, such as antimony or indium doped tin oxides or nickel or boron doped silicon oxides, can be used. Particular examples of materials include zinc oxides, tin oxides, silicon nitrides, silicon-aluminum nitrides, silicon-nickel nitrides, silicon-chromium nitrides, antimony doped tin oxide, aluminum doped zinc oxide, indium doped zinc oxide, titanium oxide, and/or mixtures thereof. Base layer 44 can include a single material. Alternatively, base layer 44 can include multiple materials and/or multiple layers.

Base layer 44 can allow adjustment of the constructive and destructive optical interference of electromagnetic radiation partially reflected from, and/or partially transmitted by, the various interface boundaries of the layers of enhanced p-polarized reflective coating 36. Additionally, base layer 44 can provide chemical and/or mechanical protection for other layers of enhanced p-polarized reflective coating 36, such as metal functional layers 46, 50, and/or 62.

Where high visible light transmittance is desired, base layer 44 can act as an antireflective layer to anti-reflect metal functional layers 46, 50, and/or 62 to reduce the overall visible light reflectance and/or increase the visible light transmittance of enhanced p-polarized reflective coating 36. Materials having refractive indices around 2 are particularly useful for anti-reflection of metal functional layers 46, 50, and/or 62.

In the illustrated exemplary enhanced p-polarized reflective coating 36, base layer 44 can be positioned over at least a portion of substrate 42 (which can be one of surfaces 24, 26, 30, and/or 32 of one of plies 22 and/or 28). Base layer 44 can be a single layer or can include one or more films of anti-reflective materials and/or dielectric materials described above. Base layer 44 can be transparent to visible light.

As discussed above, base layer 44 can include a metal oxide, a metal nitride, a mixture of metal oxides, a mixture of metal nitrides, a metal alloy oxide, and/or a metal alloy nitride. For example, base layer 44 can include oxides of zinc and tin, can include an oxide of tin, or can include a nitride of silicon.

Base layer 44 can have a thickness as described below in any of Tables 1-3. Base layer 44 can include a multi-film structure having a first film 66 and/or a second film 68. First film 66 can be, e.g., a metal alloy oxide film. Second film 68 can be, e.g., a metal oxide film, a film including a mixture of metal oxides, a metal nitride film or a film including a mixture of metal nitrides. Second film 68 can be positioned over first film 66.

First film 66 can be a zinc/tin alloy oxide. By “zinc/tin alloy oxide” is meant both true alloys and also mixtures of the oxides. The zinc/tin alloy oxide can be that obtained from magnetron sputtering vacuum deposition from a cathode of zinc and tin. The cathode can include zinc and tin in proportions of 5 weight percent to 95 weight percent zinc and 95 weight percent to 5 weight percent tin, such as 10 weight percent to 90 weight percent zinc and 90 weight percent to 10 weight percent tin. However, other ratios of zinc to tin could also be used. An exemplary metal alloy oxide for first film-66 can be written as ZnₓSn₁₋ₓO₂₋ₓ (Formula 1) where “x” varies in the range of greater than 0 to less than 1. For instance, “x” can be greater than 0 and can be any fraction or decimal between greater than 0 to less than 1. The stoichiometric form of Formula 1 is “Zn₂SnO₄”, commonly referred to as zinc stannate. A zinc stannate layer can be sputter deposited from a cathode having 52 weight percent zinc and 48 weight percent tin in the presence of oxygen. For example, first film 66 can include zinc stannate.

Second film 68 can include a metal oxide film. For example, second film 68 can include zinc oxide. The zinc oxide can be deposited from a zinc cathode that includes other materials to improve the sputtering characteristics of the cathode. For example, the zinc cathode can include a small amount of tin (e.g., up to 10 weight percent, such as up to 5 weight percent) to improve sputtering. Thus, the resultant zinc oxide film can include a small percentage of tin oxide, e.g., up to 10 weight percent tin oxide, e.g., up to 5 weight percent tin oxide. A coating layer deposited from a zinc cathode having up to 10 weight percent tin is referred to herein as “a zinc oxide film” even though a small amount of tin oxide (e.g., up to 10 weight percent) can be present. The tin in the cathode is believed to form tin oxide in the predominantly zinc oxide second film 68.

### Metal Functional Layers

At least one of metal functional layers 46, 50, and/or 62 can be a continuous metal layer. By “continuous” metal layer is meant an unbroken or non-disconnected layer, such as a homogeneous layer.

Metal functional layers 46, 50, and/or 62 provide reflectance of electromagnetic radiation in at least a portion of the infrared radiation region of the electromagnetic spectrum, for example, in the solar infrared radiation region and/or the thermal infrared radiation region of the electromagnetic spectrum.

Examples of materials useful for metal functional layers 46, 50, and/or 62 include noble or near noble metals. Examples of such metals include silver, gold, platinum, palladium, osmium, iridium, rhodium, ruthenium, copper, mercury, rhenium, aluminum, and combinations thereof. For example, one or more of metal functional layers 46, 50, and/or 62 can include metallic silver.

First metal functional layer 46 can be positioned over base layer 44 and can include any of the above metals. For example, first metal functional layer 46 can include silver. First metal functional layer 46 can be a continuous layer.

First metal functional layer 46 can be a continuous layer having a thickness as described below in any of Tables 1-3. Second metal functional layer 50 can be positioned over first phase adjustment layer 48. Second metal functional layer 50 can be a continuous layer including silver. Second metal functional layer 50 can be a continuous layer having a thickness as described below in any of Tables 1-3.

Third metal functional layer 62 can include any of the materials discussed above with respect to first or second metal functional layers 46, 50. For example, third metal functional layer 62 can include silver. Third metal functional layer 62 can be a continuous layer positioned over second phase adjustment layer 60. For example, third metal functional layer 62 can be a continuous layer having a thickness as described below in any of Tables 1-3.

Metal functional layer 46, second metal functional layer 50 and optional third metal functional layer 62 have a combined thickness. The combined thickness can be in any of the ranges described below in any of Tables 1-3. In embodiments that only comprise first and second metal functional layers 46 and 50, the combined thickness can be in any of the ranges described below in any of Tables 1-3.

### Primer Layers

While not illustrated in FIGS. 1-7, the enhanced p-polarized coating of the present invention can further comprise one or more primer layers (alternatively, throughout this specification, the one or more primer layers can be referred to as one or more sacrificial metal layers) that are positioned between each of first metal functional layer 46 and first phase adjustment layer 48, between second metal functional layer 50 and either topcoat layer 52 or second phase adjustment layer 60, and between third metal functional layer 62 and topcoat layer 52 (see for example FIG. 4A).

Such one or more primer layers can protect associated metal functional layers 46, 50, and/or 62 during the coating process and/or subsequent processing, such as oxidation during the deposition of the next oxide layer over a metal functional layer, and/or from thermal tempering. Such one or more primer layers can be deposited as a metal. During subsequent processing, such as the deposition of overlying phase adjustment layer 48 and/or 60 or topcoat layer 52 and/or thermal tempering, some or all of such one or more primer layers may oxidize. When oxide or nitride materials are used in overlying phase adjustment layer 48 and/or 60 or topcoat layer 52, such one or more primer layers can include oxophillic or nitrophillic materials, respectively. Such one or more primer layers need not be all the same material. Such one or more s primer layers need not be of the same thickness.

Examples of materials useful for such one or more primer layers include titanium, niobium, tungsten, nickel, chromium, iron, tantalum, zirconium, aluminum, silicon, indium, tin, zinc, molybdenum, hafnium, bismuth, vanadium, manganese, and combinations thereof.

First primer layer when positioned over first metal functional layer 46 can be a single film or a multiple film layer. First primer layer can include any of the materials described above. For example, first primer layer can include titanium, aluminum, zinc, an alloy thereof, or a mixture there. For example, first primer layer can include titanium. In another example, first primer layer can include aluminum and zinc.

Second primer layer can be positioned over second metal functional layer 50. Second primer layer can be of any of the materials as described above with respect to the first primer layer. For example, second primer layer can include titanium, aluminum, zinc, an alloy thereof, or a mixture there. For example, second primer layer can include titanium. In another example, second primer layer can include aluminum and zinc.

Third primer layer can be positioned over third metal functional layer 62. Third primer layer can be of any of the materials as described above with respect to the first or second primer layer. For example, third primer layer can include titanium, aluminum, zinc, an alloy thereof, or a mixture there. For example, third primer layer can include titanium. In another example, third primer layer can include aluminum and zinc.

Such one or more primer layers can have the same or a different thickness in the range of 10-50 Å (Angstroms), such as 20-40 Å, or even 25-35 Å. The thickness of the one or more primer layers can be chosen to provide sufficient protection to the underlying metal functional layer (e.g., such that the primer metals preferably oxidize to protect the underlying metal functional layer during deposition of overlaying layers).

### Phase Adjustment Layers

Phase adjustment layers 48 and/or 60 can be nonmetallic layers. For example, phase adjustment layers 48 and/or 60 can include dielectric or semiconductor materials. For example, phase adjustment layers 48 and/or 60 can include oxides, nitrides, oxynitrides, and/or mixtures thereof. Examples of suitable materials for phase adjustment layers 48 and/or 60 can include oxides, nitrides, or oxynitrides of titanium, hafnium, zirconium, niobium, zinc, bismuth, lead, indium, tin, and mixtures thereof. These may have small amounts of other materials, such as manganese in bismuth oxide, tin in indium oxide, etc. Additionally, oxides of metal alloys or metal mixtures can be used, such as oxides containing zinc and tin (e.g., zinc stannate), oxides of indium-tin alloys, silicon nitrides, silicon aluminum nitrides, or aluminum nitrides. Further, doped metal oxides, such as antimony or indium doped tin oxides or nickel or boron doped silicon oxides, can be used. Particular examples of materials include zinc oxides, tin oxides, silicon nitrides, silicon-aluminum nitrides, silicon-nickel nitrides, silicon-chromium nitrides, antimony doped tin oxide, aluminum doped zinc oxide, indium doped zinc oxide, titanium oxide, and/or mixtures thereof.

Phase adjustment layers 48 and/or 60 can include a single material. Alternatively, phase adjustment layers 48 and/or 60 can include multiple materials and/or multiple layers. The different phase adjustment layers 48 and/or 60 can include the same or different materials. Phase adjustment layers 48 and/or 60 can have the same or different thicknesses.

Phase adjustment layers 48 and/or 60 can allow adjustment of the constructive and destructive optical interference of electromagnetic radiation partially reflected from, and/or partially transmitted by, the various interface boundaries of the layers of enhanced p-polarized reflective coating 36. Varying the thicknesses and/or compositions of phase adjustment layers 48 and/or 60 can change the overall reflectance, transmittance, and/or absorptance of enhanced p-polarized reflective coating 36, which can alter the solar control performance, thermal infrared insulating performance, color, and/or aesthetics of enhanced p-polarized reflective coating 36. Additionally, phase adjustment layers 48 and/or 60 can provide chemical and/or mechanical protection for other layers of enhanced p-polarized reflective coating 36, such as metal functional layers 46, 50, and/or 62.

Where high visible light transmittance is desired, phase adjustment layers 48 and/or 60 can act as anti-reflective layers to anti-reflect metal functional layers 46, 50, and/or 62 to reduce the overall visible light reflectance and/or increase the visible light transmittance of enhanced p-polarized reflective coating 36. Materials having refractive indices around 2 are particularly useful for anti-reflection of metal functional layers 46, 50, and/or 62.

First phase adjustment layer 48 can be positioned over first metal functional layer 48. First phase adjustment layer 48 can include one or more of the materials and/or films described above. First phase adjustment layer 48 can have a thickness in any of the ranges described below in any of Tables 1-3.

First phase adjustment layer 48 can be a single layer or a multilayer structure. For example, first phase adjustment layer 48 can include a first film 70, a second film 72, and a third film 74. For example, first film 70 can include a metal oxide film. For example, first film 70 can include a zinc oxide film.

For example, second film 72 can include a metal alloy oxide film. For example, second film 72 can include a zinc stannate film. For example, third film 74 can include a metal oxide film. For example, third film 74 can include a zinc oxide film. An optional second phase adjustment layer 60 can be positioned over second metal functional layer 50. Second phase adjustment layer 60 can include any of the materials and/or layers as discussed above with respect to first phase adjustment layers 48. For example, second phase adjustment layer 60 can be a multi-film structure. For example, second phase adjustment layer 60 can include a first film 80, a second film 82, and a third film 84. Second phase adjustment layer 60 can have a thickness in any of the ranges described below in any of Tables 1-3.

First film 80 can include a metal oxide layer, for example, a zinc oxide layer. Second film 82 can include a metal alloy oxide material, for example, zinc stannate. Third film 84 can include a metal oxide layer, for example, a zinc oxide layer.

### Topcoat Layer

Topcoat layer 52 can include one or more materials and/or layers as discussed above with respect to first or second phase adjustment layers 48 and/or 60. Topcoat layer 52 can have a thickness in any of the ranges described below in any of Tables 1-3. Topcoat layer 52 can include a first film 76 and a second film 78. First film 76 can include a metal oxide layer, for example, a zinc oxide layer. Second film 78 can include a metal-alloy oxide layer, for example, a zinc stannate layer.

### Overcoat

Enhanced p-polarized reflective coating 36 can include an overcoat 54 positioned over topcoat layer 52. Overcoat 54 can be deposited over topcoat layer 52 to assist in protecting the underlying layers from mechanical and chemical attack during processing. Overcoat 54 can be an oxygen barrier coating layer to prevent or reduce the passage of ambient oxygen into the underlying layers of enhanced p-polarized reflective 36, such as during heating or bending. Overcoat 54 can be of any desired material or mixture of materials. In one exemplary embodiment, overcoat 54 can include a layer having one or more metal oxide materials, such as but not limited to oxides of aluminum, silicon, or mixtures thereof (e.g., be a silica and alumina coating). For example, overcoat 54 can be a single coating layer including in the range of 0 weight percent to 100 weight percent alumina and/or 100 weight percent to 0 weight percent silica, such as 5 weight percent to 95 weight percent alumina and 95 weight percent to 5 weight percent silica, such as 10 weight percent to 90 weight percent alumina and 90 weight percent to 10 weight percent silica, such as 15 weight percent to 90 weight percent alumina and 85 weight percent to 10 weight percent silica, such as 50 weight percent to 75 weight percent alumina and 50 weight percent to 25 weight percent silica, such as 50 weight percent to 70 weight percent alumina and 50 weight percent to 30 weight percent silica, such as 35 weight percent to 100 weight percent alumina and 65 weight percent to 0 weight percent silica, e.g., 70 weight percent to 90 weight percent alumina and 30 weight percent to 10 weight percent silica, e.g., 75 weight percent to 85 weight percent alumina and 25 weight percent to 15 weight percent of silica, e.g., 88 weight percent alumina and 12 weight percent silica, e.g., 65 weight percent to 75 weight percent alumina and 35 weight percent to 25 weight percent silica, e.g., 70 weight percent alumina and 30 weight percent silica, e.g., 60 weight percent to less than 75 weight percent alumina and greater than 25 weight percent to 40 weight percent silica. Overcoat 54 can be a single coating layer including 85 weight percent silica and 15 weight percent alumina. Other materials, such as aluminum, chromium, hafnium, yttrium, nickel, boron, phosphorous, titanium, zirconium, and/or oxides thereof, can also be present, such as to adjust the refractive index of overcoat 54. In one non-limiting example, the refractive index of overcoat 54 can be in the range of 1 to 3, such as 1 to 2, or such as 1.4 to 2, such as 1.4 to 1.8.

Overcoat 54 can be a combination silica and alumina coating. Overcoat 54 can be sputtered from two cathodes (e.g., one silicon and one aluminum) or from a single cathode containing both silicon and aluminum. This silicon/aluminum oxide overcoat 54 can be written as SiₓAl₁₋ₓO_{1.5+x/2}, where “x” can vary from greater than 0 to less than 1.

Alternatively, overcoat 54 can be a multi-layer coating formed by separately formed layers of metal oxide materials, such as, but not limited to, a bilayer formed by one metal oxide-containing layer (e.g., a silica and/or alumina-containing first layer) formed over another metal oxide-containing layer (e.g., a silica and/or alumina-containing second layer). The individual layers of the multi-layer protective coating can be of any desired thickness.

Overcoat 54 can be of any desired thickness. In one non-limiting embodiment, overcoat 54 can be a silicon/aluminum oxide coating (SiₓAl₁₋ₓO_{1.5+x/2}) having a thickness in any of the ranges described below in any of Tables 1-3.

### Interlayer

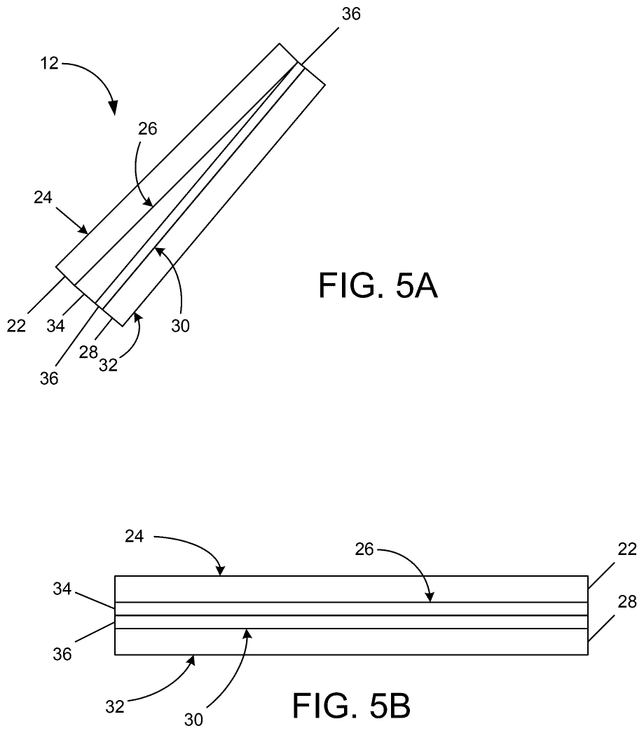

Referring to FIGS. 5A and 5B, laminate 12 can include interlayer 34. Interlayer 34 can be of a suitable material so as to hold plies 22 and 28 together. Interlayer 34 can be made of a polymer, such as polyvinyl butyral (PVB). Interlayer 34 can be positioned over second surface 26 and/or third surface 30. Interlayer 34 can be in contact with enhanced p-polarized reflective coating 36. Interlayer 34 can be of any suitable thickness to hold plies 22 and 28 together. Interlayer 34 can be a 0.76 mm thick interlayer 34 of PVB.

Referring to FIG. 5A, first ply 22 can be non-parallel relative to second ply 28. Interlayer 34 can be positioned between first ply 22 and second ply 28 and can be wedge-shaped. The wedge-shape of interlayer 34 can be configured such that radiation 16 reflects off of laminate 12 at the proper angle to avoid ghosting (e.g., to avoid seeing multiple images based on the direction of the light reflecting off of laminate 12 converging at different points).

Referring to FIG. 5B, interlayer 34 can be a layer of uniform thickness in other arrangements of laminate 12, as interlayer 34 might not need to be wedge-shaped to avoid the ghosting issue because other aspects of the design of laminate 12 counteract ghosting.

### Additional Coating Layers

As previously discussed, laminate 12 can include additional layers beyond enhanced p-polarized reflective coating 36. Laminate 12 can include anti-reflective coating 38. Anti-reflective coating 38 can be positioned over first surface 24 and/or fourth surface 32. The anti-reflective coating can comprise alternating layers of relatively high and low index of refraction materials. A “high” index of refraction material is any material having a higher index of refraction than that of the “low” index material. The low index of refraction material can be a material having an index of refraction of less than or equal to 1.75. Non-limiting examples of such materials include silica, alumina, and mixtures or combinations thereof. The high index of refraction material is a material having an index of refraction of greater than 1.75. Non-limiting examples of such materials include zirconia and zinc stannate. The anti-reflective coating can be, for example, a multi-layer coating having a first metal alloy oxide layer (first layer), a second metal oxide layer (second layer), a third metal alloy oxide layer (third layer), and a metal oxide top layer (fourth layer). In one non-limiting example, the fourth layer (upper low index layer) comprises silica or alumina or a mixture or combination thereof, the third layer (upper high index layer) comprises zinc stannate or zirconia or mixtures or combinations thereof, the second layer (bottom low index layer) comprises silica or alumina or a mixture or combination thereof, and the first layer (bottom high index layer) comprises zinc stannate or zirconia or mixtures or combinations thereof. Other suitable anti-reflective coatings are disclosed in U.S. Pat. No. 6,265,076 at column 2, line 53 to column 3, line 38; and Examples 1-3. Further suitable anti-reflective coatings are disclosed in U.S. Pat. No. 6,570,709 at column 2, line 64 to column 5, line 22; column 8, lines 12-30; column 10, line 65 to column 11, line 11; column 13, line 7 to column 14, line 46; column 16, lines 35-48; column 19, line 62 to column 21, line 4; Examples 1-13; and Tables 1-8.

Anti-reflective coating 38 can reduce the overall visible light reflectance and/or increase the visible light transmittance of enhanced p-polarized reflective coating 36. Materials having refractive indices around 2 are particularly useful for anti-reflective coating 38. It will be appreciated that applying an anti-reflective coating 38 over first surface 24 or fourth surface 32 can alter the Brewster's angle from the Brewster's angle of an air to glass interface or glass to air interface to the Brewster's angle of the air to anti-reflective coating material interface or the anti-reflective coating material to air interface. In this way, the amount of p-polarized radiation reflected and refracted can be altered compared to the case of the air to glass interface or the glass to air interface by including anti-reflective coating 38.

The display system laminate of the present invention can, in one instance, have two metal functional layers, three metal functional layers, or even four metal functional layers. In embodiments with only two metal functions layers, the enhanced p-polarized reflective coating can have the following ranges of thicknesses for each layer as detailed in Table 1.

TABLE 1

| | | | More | Most |
|---|---|---|---|---|
| | | Preferred | Preferred | Preferred |
| | Thickness | Thickness | Thickness | Thickness |
| Layer | (Å) | (Å) | (Å) | (Å) |
| Base Layer | 300-500 | 325-475 | 350-450 | 375-425 |
| 1^{st} Metal | 50-100 | 60-90 | 65-85 | 70-80 |
| 1^{st} Phase Adjustment | 1100-1400 | 1150-1350 | 1175-1325 | 1200-1300 |
| 2^{nd} Metal | 40-100 | 50-90 | 60-80 | 65-75 |
| Topcoat | 200-600 | 250-550 | 300-500 | 350-450 |
| Overcoat | 350-850 | 400-800 | 450-750 | 500-700 |
| Total Thickness | 2040-3550 | 2235-3355 | 2400-3190 | 2560-3030 |
| Total Metal Thickness | 90-200 | 110-180 | 125-165 | 135-155 |

As to the embodiments disclosed in Table 1 above, although not listed therein, one or more primer layers can independently be formed over each of the first metal layer and/or the second metal layer. In the case where such one or more primer layers are present, each primer layer can independently have a thickness in the range of 10-50 Å, such as 20-40 Å, or even 25-35 Å.

In embodiments with only three metal functions layers, the enhanced p-polarized reflective coating can have the following ranges of thicknesses for each layer as detailed in Table 2.

TABLE 2

| | | | More | Most |
|---|---|---|---|---|
| | | Preferred | Preferred | Preferred |
| | Thickness | Thickness | Thickness | Thickness |
| Layer | (Å) | (Å) | (Å) | (Å) |
| Base Layer | 300-500 | 325-475 | 350-450 | 375-425 |
| 1^{st} Metal | 50-100 | 60-90 | 65-85 | 70-80 |
| 1^{st} Phase Adjustment | 1100-1400 | 1150-1350 | 1175-1325 | 1200-1300 |
| 2^{nd} Metal | 40-100 | 50-90 | 60-80 | 65-75 |
| 2^{nd} Phase Adjustment | 300-950 | 325-925 | 335-915 | 350-900 |
| 3^{rd} Metal | 50-100 | 60-90 | 65-85 | 70-80 |
| Topcoat | 200-600 | 250-550 | 300-500 | 350-450 |
| Overcoat | 350-850 | 400-800 | 450-750 | 500-700 |
| Total Thickness | 2390-4600 | 2620-4370 | 2800-4190 | 2980-4010 |
| Total Metal Thickness | 140-300 | 170-270 | 190-250 | 205-235 |

As to the embodiments disclosed in Table 2 above, although not listed therein, one or more primer layers can independently be formed over each of the first metal layer, the second metal layer, and/or the third metal layer. In the case where such one or more primer layers are present, each primer layer can independently have a thickness in the range of 10-50 Å, such as 20-40 Å, or even 25-35 Å.

In embodiments with only four metal functions layers, the enhanced p-polarized reflective coating can have the following ranges of thicknesses for each layer as detailed in Table 3.

TABLE 3

| | | | More | Most |
|---|---|---|---|---|
| | | Preferred | Preferred | Preferred |
| | Thickness | Thickness | Thickness | Thickness |
| Layer | (Å) | (Å) | (Å) | (Å) |
| Base Layer | 300-500 | 325-475 | 350-450 | 375-425 |
| 1^{st} Metal | 50-100 | 60-90 | 65-85 | 70-80 |
| 1^{st} Phase Adjustment | 1100-1400 | 1150-1350 | 1175-1325 | 1200-1300 |
| 2^{nd} Metal | 40-100 | 50-90 | 60-80 | 65-75 |
| 2^{nd} Phase Adjustment | 300-950 | 325-925 | 350-900 | 375-875 |
| 3^{rd} Metal | 50-100 | 60-90 | 65-85 | 70-80 |
| 3^{rd} Phase Adjustment | 300-950 | 325-925 | 335-915 | 350-900 |
| 4^{th} Metal | 50-100 | 60-90 | 65-85 | 70-80 |
| Topcoat | 200-600 | 250-550 | 300-500 | 350-450 |
| Overcoat | 350-850 | 400-800 | 450-750 | 500-700 |
| Total Thickness | 2740-5650 | 3005-5385 | 3215-5175 | 3425-4965 |
| Total Metal Thickness | 190-400 | 230-360 | 255-335 | 275-315 |

As to the embodiments disclosed in Table 3 above, although not listed therein, one or more primer layers can independently be formed over each of the first metal layer, the second metal layer, the third metal layer and/or the fourth metal layer. In the case where such one or more primer layers are present, each primer layer can independently have a thickness in the range of 10-50 Å, such as 20-40 Å, or even 25-35 Å.

### Brewster's Angle

The Brewster's angle is defined as an angle of incidence at which p-polarized radiation is perfectly transmitted through the surface of laminate 12 contacted by the p-polarized radiation. In other words, the Brewster's angle is the angle of incidence at which all p-polarized radiation is refracted/transmitted such that no p-polarized radiation is reflected.

The Brewster's angle for an air to glass interface (such as when laminate 12 is glass) is approximately 57 degrees. The Brewster's angle for a glass to air interface (such as when laminate 12 is glass) is approximately 33 degrees. Thus, when the incidence angle of radiation 16 hitting fourth surface 32 of laminate 12 from radiation source 14 on an inner side of laminate 12 having an air to glass interface is 57 degrees, all p-polarized radiation is refracted and none is reflected off of fourth surface 32 to eye 20 of the user.

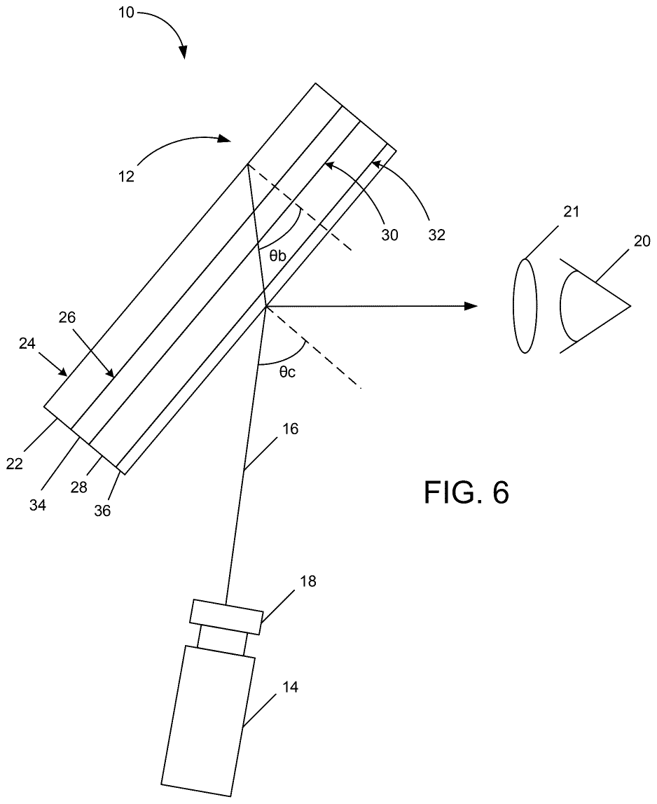

Referring to FIG. 6, the Brewster's angle of fourth surface 32 of system 10 can be altered by positioning enhanced p-polarized reflective coating 36 over first surface 24 or fourth surface 32. In FIG. 6, enhanced p-polarized reflective coating 36 is positioned over fourth surface 32. In this case, the Brewster's angle at fourth surface 32 becomes the Brewster's angle for the air to enhanced p-polarized reflective coating 36 interface.

With continued reference to FIG. 6, ghosting can be eliminated by positioning enhanced p-polarized reflective coating 36 on first surface 24 or fourth surface 32 by adjusting the angle at which radiation 16 hits enhanced p-polarized reflective coating 36. An example will be explained with enhanced p-polarized reflective coating 36 positioned over fourth surface 32, as shown in FIG. 6. Radiation 16 can contact enhanced p-polarized reflective coating 36 at a coating incidence angle θc. This coating incidence angle θc can be selected such that an incidence angle θb at first surface 24 is the Brewster's angle for the glass to air interface. In other words, coating incidence angle θc can be selected such that incidence angle θb is 33 degrees. In this scenario, p-polarized radiation reflects off of enhanced p-polarized reflective coating 36 at fourth surface 32 to eye 20 of the user but does not reflect off of first surface 24 to eye 20 of the user because all p-polarized radiation is refracted through at the Brewster's angle. If a polarized filter 18 is used to filter substantially all s-polarized radiation prior to reaching laminate 12, only p-polarized radiation reflected off of enhanced p-polarized reflective coating 36 at fourth surface 32 (as shown in FIG. 6) reaches eye 20 of the user, and ghosting is therefore reduced or eliminated. It will be appreciated that enhanced p-polarized reflective coating 36 can be positioned over first surface 24 and radiation 16 can be directed at laminate 12 such that radiation 16 contacts fourth surface 32 at the Brewster's angle of that air to glass interface (57 degrees) interface and contacts first surface 24 at an angle that is not the Brewster's angle of that glass to enhanced p-polarized reflective coating 36 interface.

### Test Configuration

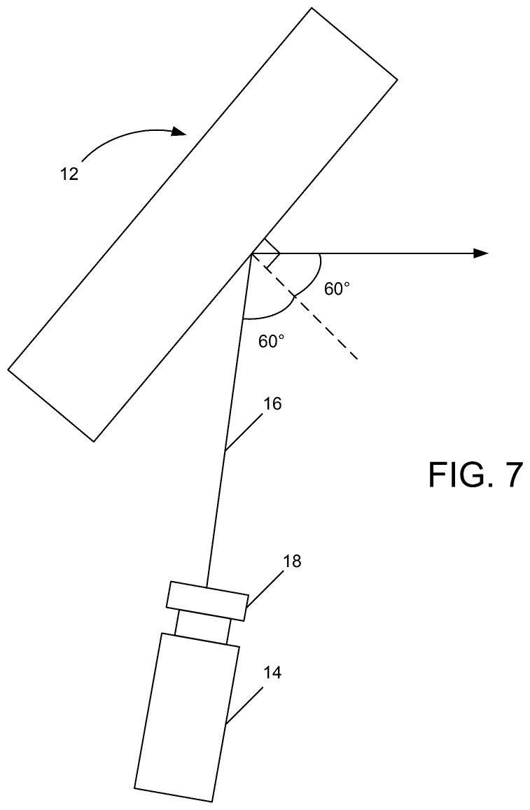

Referring to FIG. 7, a test apparatus for which radiation 16 from radiation source 14 contacts laminate 12 at an angle of 60 degrees relative to normal of laminate 12 is shown. In the test apparatus of FIG. 7, radiation source 14 is positioned such that radiation 16 emitted therefrom contacts laminate 12 at an incident angle of 60 degrees relative to normal of laminate 12. Properties (reference laminated values) of laminate 12 and reflected radiation 16 can be measured from the test apparatus of FIG. 7.

Using the test apparatus of FIG. 7, laminate 12, including the previously described first ply 22, second ply 28, interlayer 34, and enhanced p-polarized reflective coating 36, can exhibit a luminous transmittance using standard illuminate A (LTA) of at least 70 percent, as measured according automotive industry standards. Using the test apparatus of FIG. 7, laminate 12, including the previously described first ply 22, second ply 28, interlayer 34, and enhanced p-polarized reflective coating 36, can exhibit a reflectivity of the p-polarized radiation using D65 illuminate and a 10 degrees detector of at least 10 percent. Using the test apparatus of FIG. 7, laminate 12, including the previously described first ply 22, second ply 28, interlayer 34, and enhanced p-polarized reflective coating 36, can have a total reflectivity of up to 60 percent, such as up to 55 percent or up to 52 percent.

Regarding any numerical values disclosed in the specification (including any one or more numerical values from any one or more of the Tables contained herein), be they individual values in one or more examples, or from one or more portions of a numerical range, any of these individual numerical values can be combined with any other numerical value of a similar nature to form a new and/or non-disclosed range. That is, for example, any individual base layer thickness value can be combined with any other different base layer thickness value to yield a new non-disclosed base layer thickness numerical range. Further, any individual numerical value from a given layer component, a given layer thickness, or even a given single layer thickness value can be combined with any other different respective numerical value from a given layer component, a given layer thickness, or even a given single layer thickness to yield a new non-disclosed numerical range for one or more of any layer thickness values disclosed herein.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A laminate having enhanced p-polarized radiation reflecting properties comprising:
a first ply comprising a first surface and a second surface opposite the first surface, wherein the first surface comprises an outer surface of the laminate;
a second ply comprising a third surface adjacent the second surface and a fourth surface opposite the third surface, wherein the fourth surface comprises an inner surface of the laminate;
an interlayer positioned between the first ply and the second ply; and
an enhanced p-polarized reflective coating positioned over at least a portion of at least one of the second surface and/or third surface, wherein the enhanced p-polarized reflective coating comprises:
a base layer positioned over the portion of the at least one of the surfaces;
a first metal functional layer positioned over at least a portion of the base layer;
a first phase adjustment layer positioned over at least a portion of the first metal functional layer;
a second metal functional layer positioned over at least a portion of the first phase adjustment layer;
a topcoat layer positioned over at least a portion of the second metal functional layer; and
an optional overcoat positioned over at least a portion of the topcoat layer,
wherein the laminate comprises an average p-polarized reflectance of 10-20%, or 13-20%, or even 15-20% across the range of 440 nm to 680 nm at an incidence angle of 60 degrees.

2. The laminate of claim 1, wherein the enhanced p-polarized reflective coating further comprises a second phase adjustment layer positioned over at least a portion of the second metal functional layer; and a third metal functional layer positioned over at least a portion of the second phase adjustment layer, wherein when the second phase adjustment layer and the third metal functional layer are present the topcoat layer and the overcoat layer are positioned over at least a portion of the third metal functional layer.

3. The laminate of claim 2, wherein the first phase adjustment layer and/or the second phase adjustment layer comprises a first film comprising a metal oxide film; a second film positioned over the first film, the second film comprising a metal-alloy oxide film; and a third film positioned over the second film, the third film comprising a metal oxide film.

4. The laminate of claim 3, wherein any of the metal oxide films of the first film and/or third film are formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

5. The laminate of claim 3, wherein the metal-alloy oxide film is formed from either (i) a first layer of zinc oxide, a layer of zinc stannate formed over the first layer of zinc oxide, and a second layer of zinc oxide formed over the zinc stannate layer; (ii) a layer of zinc stannate formed over a layer of zinc oxide; (iii) a layer of zinc oxide formed over a layer of zinc stannate; or (iv) a layer of zinc stannate.

6. The laminate of claim 1, wherein the laminate comprises an average p-polarized reflectance of 10-20% across the range of 470 nm to 620 nm at an incidence angle of 60 degrees.

7. The laminate of claim 1, wherein the laminate comprises a p-polarized reflectance of 15-20% at 530 nm at an incidence angle of 60 degrees.

8. The laminate of claim 1, wherein the base layer comprises a first film comprising a metal oxide, metal-alloy oxide, metal nitride, or metal alloy-nitride, and a second film over the first film of the base layer, the second film of the base layer comprising a metal oxide that is different than the metal oxide of the first film of the base layer.

9. The laminate of claim 1, wherein the topcoat layer comprises first film comprising a metal oxide, a metal-alloy oxide, a metal nitride, or a metal alloy-nitride, and a second film over the first film of the topcoat layer comprising a metal oxide, a metal-alloy oxide, a metal nitride, a metal alloy-nitride, a metal oxynitride, or a metal alloy oxynitride that is different than the material used to form the first film of the topcoat layer.

10. The laminate of claim 2, further comprising one or more of a first primer over the first metal functional layer, a second primer over the second metal functional layer, and/or a third primer over the third metal functional layer.

11. A system for projecting an image comprising a projector configured to project a p-polarized image towards a laminate having enhanced p-polarized radiation reflecting properties, the laminate comprising the enhanced p-polarized reflective coating of claim 1.

12. A method for reflecting p-polarized light, the method comprising the steps of:
providing at least one projector configured to project a p-polarized image towards a laminate having enhanced p-polarized radiation reflecting properties; and
projecting at least one p-polarized light image towards the laminate, wherein the laminate comprises the enhanced p-polarized reflective coating of claim 1.

13. A vehicle having at least one display system designed to reflect p-polarized light, the display system comprising:
a projector configured to project a p-polarized image towards a laminate having enhanced p-polarized radiation reflecting properties; and
at least one laminate designed to reflect p-polarized light, the laminate comprising the enhanced p-polarized reflective coating of claim 1.
